(19) United States
(12) Patent Application Publication
(10) Pub. No.: US 2025/0326311 A1
(43) Pub. Date: Oct. 23, 2025

(54) ELECTRIC VEHICLE CHARGER AND NETWORK OF ELECTRIC VEHICLE CHARGERS

(71) Applicants: Jan PENCZEK, Chelm Slaski (PL); ENERGIA ODNAWIALNA BADANIA I WYTWARZANIE SP Z. O.O., Dabrowa Gornicza (PL)

(72) Inventors: Jan PENCZEK, Chelm Slaski (PL); Ireneusz CWILAG, Katowice (PL)

(21) Appl. No.: 18/852,471

(22) PCT Filed: Mar. 31, 2023
(86) PCT No.: PCT/IB2023/053253

§ 371 Date: Sep. 29, 2024

(30) Foreign Application Priority Data
Apr. 5, 2022 (PL) PL440855

(51) Int. Cl. B60L 53/53; B60L 53/67; B60L 53/68; B60L 55/00

(52) U.S. Cl. CPC B60L 53/53; B60L 53/67; B60L 53/68; B60L 55/00; B60L 2210/14; B60L 2210/30; B60L 2210/42

(57) ABSTRACT

The invention related to a charger for electric vehicles, which comprises an input AC-DC converter from an external power grid, an energy storage battery, a DC-DC converter for charging an electric vehicle, a charging port for an electric vehicle as well as a controller configured to establish interconnections between the DC-DC converter and the input AC-DC converter or the energy storage battery with charging port of an electric vehicle for charging the electric vehicle or for charging energy storage battery. Further the charger comprises at least one supplementary DC-DC converter and an output DC-AC inverter to the external power grid, where the controller is configured to make additional, selective switching in response to input signals received from an electric vehicle and/or from the energy storage battery and/or from the external power grid. The application discloses further a network of chargers for charging electric vehicles.

This invention refers to an electric vehicles charger, and more specifically to an electric vehicles charger integrated with a battery designed to store electric energy and to balance electricity consumption at the level of an electric vehicle and on the level of an electric power grid, as well as to a network of electric vehicles chargers.

The present time is an era of energy source transformation. In about a dozen of years all newly registered automotive vehicles are supposed to be electric ones. By that time an infrastructure system to recharge electric vehicles must be deployed, which may be a substantial load to the electric power grid. Although home-based chargers for electric vehicles shall be able to keep delivery and demand for electricity balanced owing to utilization of out-of-peak electric power but high-power chargers to be installed down transport routes may become a disturbing factor for electric power grid and make it unbalanced. Very high consumption of electric power by charging stations may lead to temporary overloads to supply lines for charging facilities while a great number of chargers supplied from a local grid may cause an overload to an entire power mains. To prevent such overloads charging ports are more and more frequent provided with energy storage facilities such as rechargeable batteries.

Some remedial solutions have already been revealed within the existing state-of-the-art in the technology of high power chargers. For instance, the patent description U.S. Pat. No. 7,768,229 B2 discloses a combination of a rechargeable battery with a DC charger for electric vehicles. The solution assumes that an AC-DC converter supplying electric power from the power grid is coupled, depending on the operation mode, either to a DC-DC converter of an electric vehicle charger or to a DC-DC converter designed to charge an energy storage battery. In addition, a DC-DC step-up converter is used with the energy storage battery. The energy storage battery is provided with a controller that is able to detect a low voltage state at the output of the AC-DC converter and then incorporate the energy storage battery into the charger circuit of the electric vehicle charger in between of the AC-DC converter and the DC-DC converter of the electric vehicle charger. The energy storage battery is incorporated into the circuit of an electric vehicle charger by means of an output DC-DC converter that is provided with a controller that elevates the charging voltage above the voltage detected at the output of the AC-DC converter. The patent description also indicates that a DC-AC inverter can be potentially applied to supply AC voltage from the energy storage battery to a power grid, but details of that solution are not disclosed.

Another patent description, in particular U.S. Pat. No. 9,153,847, discloses a different solution for connection of an energy storage unit to a DC charger for electric vehicles. One bidirectional DC-DC converter is used for an electric vehicle charger, one input AC-DC converter from an electric grid (power mains) and one output DC-AC inverter to an electric power grid. The bidirectional DC-DC converter of the charger is provided with a controller that enables operation of the battery in two modes when electricity is supplied to an electric vehicle and two other modes when electricity is supplied to an electric power grid. For the first operating mode of electric energy supply to an electric vehicle the bidirectional DC-DC converter of the charger is coupled by the controller to the AC-DC input converter of an electric power grid and to the electric vehicle charging port. The second mode of electric energy supply to an electric vehicle assumes that the controller establishes a connection between the bidirectional DC-DC converter of the charger, the energy storage battery and the charging port of an electric vehicle. For the first mode of electricity supply to an electric power grid the bidirectional DC-DC converter of the charging stations is connected by the controller to a battery of an electric vehicle as well as to an output AC-DC inverter to an electric power grid. The second mode of electricity supply to an electric power grid consists in coupling by the controller the bidirectional DC-DC converter of the charger to an energy storage battery and to an output DC-AC inverter to an electric power grid. The current mode of the charger operation is selected in response to information received by the controller, for instance rates for electric energy, current load of electric power grid, amount of energy from renewable sources or electric energy remaining in an electric vehicle battery.

The solutions disclosed in patent descriptions U.S. Pat. No. 7,768,229 B2 and U.S. Pat. No. 9,153,847 enable efficient compensation of peak demand for electric energy from a local area (micro) electric power grid at a charging point and/or in a specific branch of an electric grid (power mains) owing to application of an energy storage battery integrated with a charger for electric vehicles. The solution disclosed in U.S. Pat. No. 9,153,847 also assumes that batteries of electric vehicles can be used for that purposes as well. However, the mentioned solutions take no account of the fact that the characteristic curves for charging of an electric vehicle battery from a high power DC charger is non-linear, same as the charging curve of an energy storage battery in a charger. As a consequence, the periods of peak demand for electric power may occur for short times and at random moments. Therefore not only a peak demand for electric power at a charger and/or in a power grid must be take into account but also peak demands for electric power from batteries of an electric vehicle and an energy storage battery pack of a charger. These periods of peak demand for electric power may be mutually shifted in time, which requires a selective control of electric power flow and redirection of peak power provided by a charger, which is not enabled by solutions disclosed in U.S. Pat. No. 7,768,229 B2 or in U.S. Pat. No. 9,153,847.

The purpose of this invention is to present a design of an electric vehicle charger so that to enable selective balancing of the charger output power with peak demand for power from an electric vehicle battery, an energy storage battery of a charger and/or a local area (micro) grid or the electric grid (power mains).

The invention refers to an electric vehicles charger, which comprises an input AC-DC converter from an external power grid, an energy storage battery, a DC-DC converter for charging of electric vehicles, a charging port for an electric vehicle as well as a controller configured to establish interconnections between the DC-DC converter either to the input AC-DC converter or the energy storage battery at one side, and further with the charging port of an electric vehicle for charging the electric vehicle or charging of the energy storage battery at the other side, according to preamble of the independent claim no. 1. The external power grid is understood as a mains distributing power grid or a local area (micro) grid at a charger. The essence of this invention consists in the fact that the charger further comprises at least one additional DC-DC converter and an output DC-AC inverter to the external power grid, while the controller is configured for supplementary and selective switching in response to signals received from an electric vehicle and/or the energy storage battery and/or external grid, to establish connections between the supplementary DC-DC converter, the energy storage battery and the charging port of an electric vehicle and/or the output DC-AC inverter to an external power grid, to transfer electric energy from the energy storage battery for charging electric vehicle or to transfer energy from the energy storage battery to the external power grid.

Preferably the output DC-AC inverter is a bidirectional device whilst the controller is configured for selective switching to establish interconnections between the supplementary DC-DC converter and the output DC-AC inverter and/or to the charging port of an electric vehicle and/or the energy storage battery, so that to transfer electric energy from the external grid to charge an electric vehicle or for supplementary charging the energy storage battery from an external electric power grid.

Another preferred embodiment of the invention assumes that the input AC-DC converter is a bidirectional device whilst the controller is configured for selective switching to establish interconnections between the first DC-DC convertor and the input AC-DC converter, and/or the energy storage battery and/or the charging port of an electric vehicle so that energy can be transferred from the energy storage battery to the external power grid or from a battery of an electric vehicle to an external power grid.

The invention enables optimized management of peak demand for electric power with equalization of balance between an electric power grid, batteries of electric vehicles and energy storage batteries in chargers owing to application of supplementary DC-DC converters and properly configured controllers. The invention improves utilization of energy from an energy storage battery of the charger since a supplementary DC-DC converter is able to selectively increase the output power of the charger up to the peak demand required by a load while the charging process is in progress or selectively release a redundant power to an external power grid when total power consumption of loads supplied from that grid exceeds the grid capacity, which is an advantage infeasible in case of solutions disclosed in the current state-of-the-art in technology. In addition, the charger according to the present invention enables a selective transfer of energy from either the energy storage battery of the charger or from a battery of an electric vehicle to an external electric mains.

A subsequent invention refers to a network of electric vehicle chargers with the design and configuration as above in line with the preamble of the independent claim no. 4. The essence of the invention related to a network of electric vehicle chargers consists in the fact that the network comprises at least two such chargers for electric vehicles and also comprises a master controller for cooperation with an external grid. The master controller is configured to manage the controllers of electric vehicle chargers for prioritized switching, in response to signals received from energy storage batteries and from the external power grid, to establish interconnections between supplementary DC-DC converters and output DC-AC inverters to supply the external grid and with energy storage batteries to transfer energy from the energy storage batteries to the external network.

Supplementary DC-DC converters operated in a network of electric vehicle chargers are able to equalize balance between peak demand from a network of chargers and the power mains capacity when power supply from the electric mains is insufficient. The DC-DC converters can simultaneously charge electric vehicles and also release electric energy to the external power grid.

The electric vehicles charger and a network of electric vehicle chargers are detailed in the following description of the preferred embodiments of this invention and can be better understood in conjunction with the accompanying drawings, in which:

FIG. 1 is a schematic diagram of an electric vehicle charger according to the present invention;

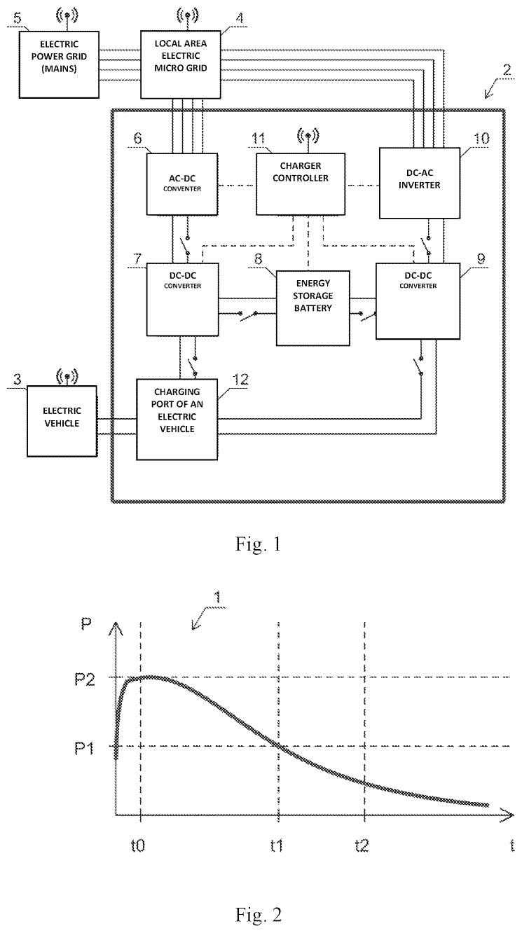

FIG. 2 is a characteristic curve for charging an electric vehicle from a DC charger according to the present invention, and

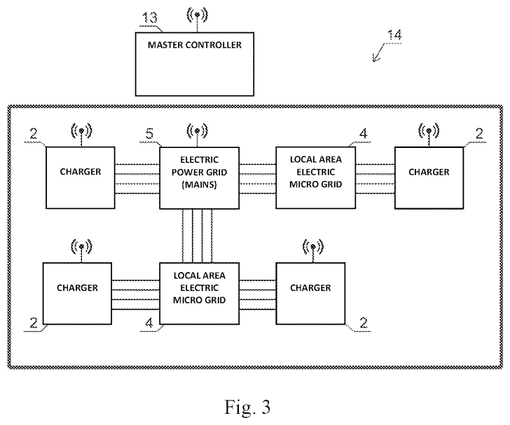

FIG. 3 is a schematic diagram of a network of electric vehicle chargers according to the present invention.

A charger 2 for electric vehicle 3 charging is connected to an external power grid that comprises a local area (micro) grid 4 deployed at the charging location and a power distributing mains 5. The charger 2 includes an input AC-DC converter from the local area (micro) grid 4 or from the power distributing mains 5, a DC-DC converter 7 designed to charge an electric vehicle 3 and coupled with the AC-DC converter 6, an energy storage battery 8 and a charging port 12 of an electric vehicle 3. In addition, a supplementary DC-DC converter 9 is coupled to the energy storage battery 8 where the said DC-DC converter 9 is coupled to the charging port 12 of an electric vehicle 3 and to an output DC-AC inverter 10 to supply a local area (micro) grid 4. The supplementary DC-DC converter 9 may comprise one or more DC-DC converter units depending on the demand of the charger 2 for electric power. In addition, the charger 2 comprises a controller 11 configured for the following tasks:
to establish a connection between the DC-DC converter 7, the input AC-DC converter 6 and the energy storage battery 8 to enable charging of the energy storage battery 8;
to establish a connection between the DC-DC converter 7, the input AC-DC converter 6 and the charging port 12 of an electric vehicle 3 to charge the electric vehicle 3;
to make additional switching in response to input signals received from an electric vehicle 3 and/or from the energy storage battery 8 and/or from the external power grid 4, 5, to establish connections between the supplementary DC-DC converter 9, the energy storage battery 8 and the port 12 of an electric vehicle 3 to charge batteries of the electric vehicle 3;
make additional switching in response to input signals received from an electric vehicle 3 and/or from the energy storage battery 8 and/or from the external power grid 4, 5, to establish connections between the supplementary DC-DC converter 9 and the output DC-AC inverter 10 to the external grid 4, 5 to supply electric power from the energy storage battery 8 to the external power grid 4, 5.

The invention enables more efficient utilization of the energy storage battery embedded into the charger since a supplementary DC-DC converter is able to selectively increase the output power of the charger up to the peak demand required by a load while the charging process is in progress or selectively release a redundant available power to the external power grid during periods of peak consumption by connected loads, which is an advantage infeasible in case of solutions disclosed in the current state-of-the-art in technology.

FIG. 2 shows a characteristic curve 1 for charging an electric vehicle 3 from a high power DC charger 2 according to the present invention. The load of the high power DC charger 2 during the charging process is non-linear. The interconnections between components of the charger 2 and the energy storage battery 8 according to the present invention take account for the peak demand P2 for power from the moment t0 to t1 when the whole power available from the charger must be redirected to a battery of the electric vehicle 3 as well as the time period with basic demand for electric power P1, lasting from t1 to t2, when only a portion of the whole output power available from the charger 2 can be supplied to a battery of the electric vehicle 3 while the remaining portion P1-P2 of the output power can be selectively redirected to a local area (micro) grid 4 of electric power and/or to the electric power mains 5.

Another beneficial embodiment of the invention assumes that the output DC-AC inverter 10 is a bidirectional device while the controller 11 is configured for the following tasks:
to establish a selective connection between the supplementary DC-DC converter 9, the output DC-AC inverter 10 and the charging port 12 of an electric vehicle 3 to enable transfer of additional power from the external power grid 4, 5 to charge the electric vehicle 3;
to establish a selective connection between the supplementary DC-DC converter 9, the output DC-AC inverter 10 and the energy storage battery 8 to enable supplementary charging of the energy storage battery 8 from the external power grid 4, 5.

One more beneficial embodiment of the invention assumes that the input AC-DC converter 6 is a bidirectional device while the controller 11 is configured for the following tasks:
to establish a selective connection between the first DC-DC converter 7, the input AC-DC converter 6 and the charging port 12 of an electric vehicle 3 to enable transfer of electric power from a battery of the electric vehicle 3 to the external power grid 4, 5;
to establish a selective connection between the first DC-DC converter 7, the input AC-DC converter 6 and the energy storage battery 8 to enable transfer of electric power from the energy storage battery 8 to the external power grid 4, 5.

The charger 2 for electric vehicles 3 is a very flexible appliance since it can simultaneously work in several modes of operation, which shall be exemplified in details in the following description.

The input AC-DC converter 6 for supply of electricity from the external grid 4, 5, the first DC-DC converter 7, the supplementary DC-DC converter 9 as well as the output DC-AC inverter 10 for transfer of electric power to the external grid 4, 5 are bidirectional devices. Therefore the charger 2 can be used to transfer electric power to the reverse direction, i.e. from a battery of the electric vehicle 3 to the energy storage battery 8 or to the external power grid 4, 5.

Another operation mode assumes that the DC-DC converter 7 can transfer the basic electric power P1 from the electric vehicle 3 to the energy storage battery 8 whilst the second DC-DC converter 9 can be used for selective transfer of the supplementary peak power P2-P1 from the electric vehicle 3 to the energy storage battery 8 when the demand for electric power from the energy storage battery 8 reaches its peak level, or for transfer of the peak power to the external power grid 4, 5 in case of peak demand for power in these grids.

Yet another operation mode allows for transfer of the basic electric power P1 from the electric vehicle 3 to the energy storage battery 8 via the first DC-DC converter 7 while the second DC-DC converter 9 is used for a selective transfer of peak power P2-P1 from the external power grid 4, 5 to the energy storage battery 8 during time periods of peak demand for electric power necessitated by that energy storage battery 8.

One more operation mode of the charger 2 consists in such a layout that the first DC-DC converter 7 can supply the basic power P1 from the external power grid 4, 5 to the energy storage battery 8 while the second DC-DC converter 9 is used for a selective transfer of peak power P2-P1 from the external power grid 4, 5 to the energy storage battery 8 when the demand of the battery 8 for electric power reaches its peak levels, or to the electric vehicle 3.

The foregoing embodiments as described herein are far away from exhausting all possible options how DC-DC convertors can be used to optimize utilization of output power available from the charger 2 and the energy battery 8.

FIG. 3 discloses a network 14 of chargers 2 designed to charge electric vehicles, where the network comprises four chargers 2 with the structures and configurations arranged according to the foregoing embodiments of the invention. The network 14 is provided with a master controller 13 designed for cooperation with the external power grid 5 and configured to manage controllers 11 of chargers 2 for electric vehicles. The master controller 14 is configured to establish of priority interconnections, according to signals received from energy storage batteries 8 and the external power grid 5, between supplementary DC-DC converters 9, output DC-AC inverters 10 to the external grid 5 and energy storage batteries 8 to enable transfer of electric energy from energy storage batteries 8 to the external power grid 5.

1. An electric vehicles charger, comprising an input AC-DC converter (6) from an external power grid (4, 5), an energy storage battery (8), a DC-DC converter (7) for charging an electric vehicle (3), a charging port (12) for an electric vehicle (3) as well as a controller (11) configured to establish interconnections between the DC-DC converter (7) and the input AC-DC converter (6) or the energy storage battery (8) at one side as well as between the said DC-DC converter (7) and the charging port (12) of an electric vehicle (3) or the charging of energy storage battery (8) at the other side, characterized in that it further comprises at least one supplementary DC-DC converter (9) and an output DC-AC inverter (10) to the external power grid (4, 5), where the controller (11) is configured to make additional, selective switching in response to input signals received from an electric vehicle (3) and/or from the energy storage battery (8) and/or from the external power grid (4, 5), to establish connections between the supplementary DC-DC converter (9), the energy storage battery (8) and the charging port (12) of an electric vehicle (3) and/or with the output DC-AC inverter (10) to the external power grid (4, 5) to transfer energy from the energy storage battery (8) for charging an electric vehicle (3) with peak power (P2) by paralleling the first DC-DC converter (7) and the second DC-DC converter (9) with the charging port (12) of the electric vehicle (3) or to transfer energy from the energy storage battery (8) to the external power grid (4, 5).

2. The electric vehicles charger according to claim 1, characterized in that the output DC-AC inverter (10) is a bidirectional device while the controller (11) is configured for selective switching to establish interconnections between the supplementary DC-DC converter (9) and the output DC-AC inverter (10) and/or the charging port (12) of an electric vehicle (3) and/or the energy storage battery (8) in order to transfer power from the external power grid (4, 5) to charge an electric vehicle (3) or to auxiliary recharge the energy storage battery (8) from the external power grid (4, 5).

3. The electric vehicles charger according to claim 1, characterized in that the input AC-DC converter (6) is a bidirectional device while the controller (11) is configured for selective switching to establish interconnections between the first DC-DC converter (7) and the input AC-DC converter (6) and/or the energy storage battery (8) and/or the charging port (12) of an electric vehicle (3) in order to transfer energy from the energy storage battery (8) to the external power grid (4, 5) or to transfer energy from a battery of the electric vehicle (3) to the external power grid (4, 5).

4. A network of electric vehicles chargers, characterized in that it comprises at least two electric vehicle chargers according to claim 1 and, in addition, it comprises a master controller (13) of an external power grid (5) where the master controller (13) is configured to manage controllers (11) of electric vehicle chargers (2) with for prioritized switching in response to signals received from energy storage batteries (8) and from the external power grid (5) to establish interconnections between supplementary DC-DC converters (9) and output DC-AC inverters (10) to supply the external power grid (5) in order to transfer power from the energy storage batteries (8) to the external power grid (5).

5. A network of electric vehicles chargers, characterized in that it comprises at least two electric vehicle chargers according to claim 2 and, in addition, it comprises a master controller (13) of an external power grid (5) where the master controller (13) is configured to manage controllers (11) of electric vehicle chargers (2) with for prioritized switching in response to signals received from energy storage batteries (8) and from the external power grid (5) to establish interconnections between supplementary DC-DC converters (9) and output DC-AC inverters (10) to supply the external power grid (5) in order to transfer power from the energy storage batteries (8) to the external power grid (5).

6. A network of electric vehicles chargers, characterized in that it comprises at least two electric vehicle chargers according to claim 3 and, in addition, it comprises a master controller (13) of an external power grid (5) where the master controller (13) is configured to manage controllers (11) of electric vehicle chargers (2) with for prioritized switching in response to signals received from energy storage batteries (8) and from the external power grid (5) to establish interconnections between supplementary DC-DC converters (9) and output DC-AC inverters (10) to supply the external power grid (5) in order to transfer power from the energy storage batteries (8) to the external power grid (5).
